(19) United States
(12) Patent Application Publication
(10) Pub. No.: US 2009/0039105 A1
(43) Pub. Date: Feb. 12, 2009

(54) Controlled removal of liquids

(76) Inventor: Lee B. Golter, Grand Junction, CO (US)

Correspondence Address: EDWIN L. HARTZ, 619 MAIN STREET, SUITE 115, GRAND JUNCTION, CO, 81501, US

(21) Appl. No.: 11/891,282

(22) Filed: Aug. 9, 2007

(51) Int. Cl. B67D 5/08

(52) U.S. Cl. 222/1

(57) ABSTRACT

A selected process, such as the removal of oil from a tank, is controlled by a sensor which monitors changes in a characteristic of the liquid that flows past the sensor to initiate the control process.

### FIELD OF THE INVENTION

Management of stratified liquids or one or more liquids having vertical gradients in a container and, more particularly, controlling the removal of liquids to limit removal to a selected liquid or liquids or the removal of a portion of a liquid within a range of selected gradients.

### BACKGROUND OF THE INVENTION

Liquids having different specific gravities and immiscibility naturally stratify in a container. Also, a liquid in a container that has temperature variances in the vertical direction will have gradients in the specific gravity at various levels. Other physical, chemical or electrical characteristics may vary in a liquid and may be sensed to aid in the management of the liquid. A particular problem arises with the stratified liquids from natural gas wells (NGLs) in storage tanks and the removal of the liquids from the tanks. The liquids stratify with the heavy material, termed bottom sediment and water, at the bottom of the tank. On top of the BS&W is water, waste oil or interface, dirty oil, clean oil. On top of the liquid is air and any gases that may be present.

The storage tanks at well sites typically have a drain port near the bottom of the tank and a load-out port a selected distance above the bottom of the tank. This distance typically being 16″ for storage tanks used in the gas fields. When it is desired to remove clean oil from a storage tank, the bottom liquids must be removed first, in gravitational order, according to their relative density, starting with the BS&W at the bottom, then water and so on. The operators of water trucks that are called in to remove the lower liquids often mistakenly, or intentionally, take oil with the water. Sometimes many barrels of oil are taken with the water and at $60.00 or more a barrel, this is a very expensive mistake. Additionally, there is not an efficient cost effective way to determine the amount of water, waste oil, dirty oil and clean oil in a storage tank for liquid management and to aid in scheduling trucking to minimize truck traffic to and from the well sites. A major consideration in issuing drilling permits for gas wells and oil wells is the impact on the environment. Limiting trucks to full loads only, whenever possible, significantly reduces truck traffic. It is desired to control the removal of the liquids in storage tanks at gas wells and at oil wells to: 1) limit water truck operators to the removal of water only, 2) to have full loads when possible for the various types of trucks that visit well sites to reduce truck traffic, and 3) to control the removal of one or more selected liquids or layers of a liquid from a tank.

The apparatus and method of managing liquids in tanks has general application but will be disclosed in the context of liquids from gas wells. Such disclosure is not a limitation on the use of the apparatus and method of this invention. The invention is broadly a system of mechanical and electronic devices designed to secure oil and gas liquid tanks, particularly those in remote areas, allowing only selective removal of certain liquids. At gas wells it is desired to permit removal of BS&W, water and interface layers, while restricting the removal of oil, except under certain defined circumstances.

### SUMMARY OF THE INVENTION

The removal of liquids from a tank is controlled by sensing one or more of the electrical, physical or chemical characteristics of the liquids. The system of this invention senses the change in the dielectric coefficient of the liquids and limits the flow of only authorized liquids through the outlet of the tank. If, for example, only water is to be removed and the sensed coefficient corresponds to that of water, the removal is permitted. However, when the sensed coefficient of the liquid changes from the coefficient of an approved liquid for removal to that of a non-approved liquid, a signal is generated. This signal is applied to an alarm to alert the person withdrawing the liquid that a non-approved liquid is being or is about to be withdrawn. This alarm alerts the person to close the valve to discontinue the removal of liquids from the tank. As an incentive and as a record, the signal may also activate a camera mounted to record information concerning the identity of the person removing the liquids and the identification of the truck used for offloading the liquids from the tank. A more secure system to prevent the removal of unauthorized liquids includes an controlled valve that is activated by a controller in response to the generated signal. Further, the system requires proof of authorization to remove a liquid from the tank. This may be done in the form of a magnetic card activated at a control station, such as a water plant, for removal of liquids from an identified tank. For further management of the liquids, such as the water recovered from the gas well and stored in a tank at the well site, the water truck operator is required to use the same form of identification and memory to record the quantity of water delivered to the water plant. This also includes the identification of the operator of the truck or the trucking company, the date and time. This system fulfills the desire to track all liquids removed from gas wells.

The dielectric coefficient of each liquid in a tank is sensed by a capacitive sensor. The sensor includes capacitor plates that are in contact with the liquids in the tank. The capacitor plates may be parallel plates having a size and spacing appropriate for the environment of use. When used in a storage tank with NGLs, the plates may be rectangular in shape, with a width of 1 centimeter and length of 8 centimeters and a spacing between the parallel flat faces of the plates of 1½ centimeters. Other configurations of the capacitor plates and sizes and spacing may be used. For example, a pair of coaxial cylindrical plates may be used or a single plate extending into liquids with the housing of the capacitive probe or tank being the second plate.

It is preferable that all of the circuitry necessary to convert the dielectric to a digital signal is within the housing of the probe that is placed inside the tank. Alternatively, some of the circuitry may be located outside the housing for the probe and outside the tank. The capacitor plates have a coating of insulating material that is resistant to corrosion and the caustic materials in a tank such as a tank containing NGLs. Further, the housing is made of a material such as polyethylene that will withstand the corrosive and caustic liquids from gas wells that are stored in storage tanks.

The NGLs include layers of liquids designated clean oil, dirty oil, waste oil (interface), water and bottom sediment and water (BS&W). These liquids are identified and defined in the BLM brochure “Onshore Oil and Gas Operations; Federal and Indian Oil & Gas Leases; Onshore Oil and Gas Order No. 4; Measurement of Oil” issued under 43 CFR 3160 and published in the Federal Register at Volume 54, No. 36, Feb. 24, 1989 and effective Aug. 23, 1989. As the liquids in the tank pass between the plates of the capacitive sensor, they function as a dielectric with a certain dielectric coefficient. In this description of the capacitive sensor and capacitive probe the characteristic of the liquid sensed will be termed dielectric and/or coefficient, with the terms being used interchangeably. The circuitry and capacitor plates of the probe function to convert the dielectric to a digital signal indicative of the coefficient of the liquid between the capacitor plates.

Many of the storage tanks for NGLs have a capacity of 400 barrels or 500 barrels and an internal height of 20 feet. These tanks typically have two 4″ openings on the top, one of which may be used for installing a capacitive sensor. A capacitive sensor may be installed in tanks that are already in use and contain volatile explosive and corrosive liquids from gas wells or may be installed in new tanks that have not yet been placed in service. In new tanks, the capacitive sensor may be attached directly to a wall at a selected distance from the bottom of the tank. The placement of the capacitive sensor will be at a distance with respect to the outlet port from which liquids are removed to sense the coefficient of the liquid approaching the outlet. In this way, as the coefficient changes from that of water to that of oil, for example, a warning or control signal will be generated. This warning or control signal may also be generated (for the change in) coefficients of different liquids other than just oil and water.

In retrofit applications, the capacitive sensor is attached to a rod of sufficient length to hold the capacitive probe in place inside the tank. The support rod and capacitive probe are inserted in the tank through one of the 4″ openings on top of the tank. The capacitive probe may be attached to the support pole to be located a fixed distance relative to the bottom of the tank and relative to one or more of the outlets of the tank. Alternatively, the capacitive probe may be mounted on a lead screw and guided on a support pole that are inserted through an opening in the top of the tank. The lead screw is rotated to position the capacitive sensor at the desired height inside the tank. A lead screw and support pole may also be used in original installation in a new tank as well as in a retrofit situation. In either case, the lead screw may have threads over essentially the complete length of the lead screw so that the capacitive sensor may be moved vertically through each of the liquids in the tank to survey the liquids and to provide information as to the contents of the tank as well as the location of each liquid or gradients in a liquid in the tank.

The ability to survey and the use of the information are described in greater detail in the patent application entitled Apparatus and Method for Content Discrimination having the docket number G113:1068 and filed concurrently with this application and the disclosure is incorporated herein by this reference as though set forth in full.

Additionally, the content discrimination probe may be set at any selected level to monitor the removal of a selected liquid from a tank. For example, if the interface layer is to be removed, the content discrimination sensor or capacitive sensor is set at the bottom of the interface layer or in the interface layer at the same level as the orifice of the variable height inlet/outlet orifice to sense when the interface layer has been removed and the next liquid layer is approaching the outlet orifice of the variable height inlet/outlet orifice tool. Any of the variable height inlet/outlet orifice tools of the PCT Application Serial Number US2006/004479 filed Feb. 8, 2006, the disclosure of which is incorporated herein by this reference as though set forth in full may be used with the content discrimination sensor. The disclosure in the Provisional Patent Application Ser. No. 60/810,013 filed May 31, 2006, is also incorporated herein by this reference as though set forth in full.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and wherein:

FIG. 1 is a block diagram of a capacitive sensor, including a dielectric to digital converter, in accordance with the present invention;

FIG. 2 is a functional block diagram of a capacitance to digital converter used in the capacitive probe, in accordance with the present invention;

FIG. 3 is a block diagram of an alternative circuit for a dielectric to digital converter, in accordance with the present invention;

FIG. 4 is an illustrative diagram of a storage tank including a capacitive sensor, in accordance with the present invention;

FIG. 5 is an illustrative diagram of a storage tank containing natural gas liquids with a moveable capacitive probe, in accordance with the present invention;

FIG. 6 is a top-plan view of the capacitive probe in place in the tank along the section lines 7-7 of FIG. 6, in accordance with the present invention;

FIG. 7 is a front-elevation view of the capacitive probe and carrier on a lead screw, in accordance with the present invention;

FIG. 8 is a top-plan view of the carrier and the capacitive probe, in accordance with the present invention; and

FIG. 9 is a schematic diagram of the capacitive probe in a tank attached to a variable height inlet/outlet orifice, in accordance with the present invention.

### DETAILED DESCRIPTION OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Different physical, chemical and/or electrical characteristics of liquids in a tank can be sensed to determine the contents of the tank and when coupled with means for determining the position in the tank, the transitions from one liquid to another can also be determined. The different dielectric coefficients of liquids in a tank may be used to discriminate and identify the various liquids in a tank. Further, by sensing the dielectric coefficient of liquids that are being removed from a tank, it is possible to tell when the removal of one liquid has been completed and the removal of a different liquid is beginning.

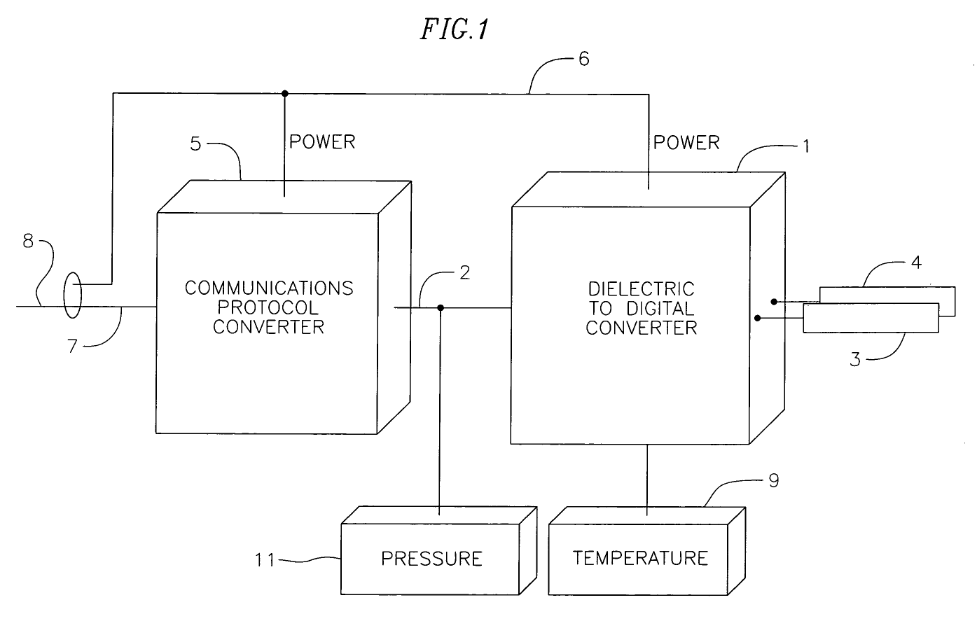

A capacitive probe is used to detect the coefficients of the liquids between the capacitor plates of the probe and creates an output signal indicative of the coefficient and therefore the type of liquid between the capacitor plates of the probe. The liquid or dielectric is identified and converted to a digital signal. A dielectric to digital converter creates a digital signal out which may be called the converted coefficient of the dielectric (liquid) in contact with the capacitor plates. Such a dielectric to digital converter 1 is shown in block form in FIG. 1. A pair of capacitor plates 3 and 4 are electrically connected to the dielectric to digital converter 1. The digital signal or converted coefficient that is the output of the converter 1 is applied as an input to a communication protocol converter 5 as shown in FIG. 1. Power is provided to both converters by a cable 6 that combines with a data output cable 7 from converter 5 as a power and data cable 8. The two converters 1 and 5 may advantageously be housed in the housing for the capacitance probe with the power and data cable communicating with circuitry outside of the tank in which the capacitive probe is located. The dielectric to digital 1 may also have an input from a temperature sensor such as an RTD, thermistor or diode. In this way, the temperature of the liquid or dielectric between the capacitor plates 3 and 4 may also monitored. Additionally, the converter 5 may have an input from a pressure sensor 11 that is useful in determining the volume of the liquid above the capacitor plates 3 and 4 when there is only one type of liquid above the pressure transducer 11 in the tank.

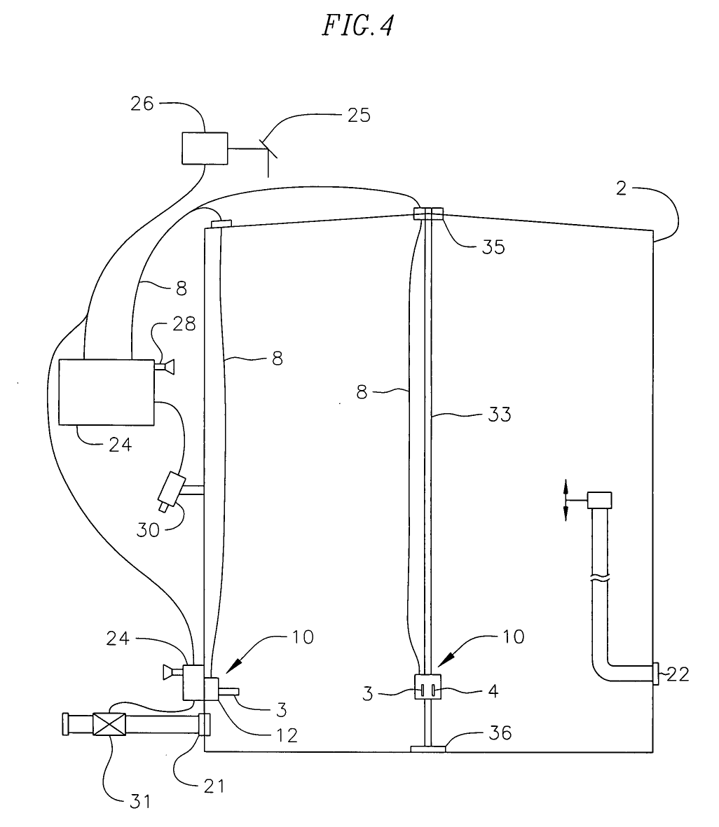

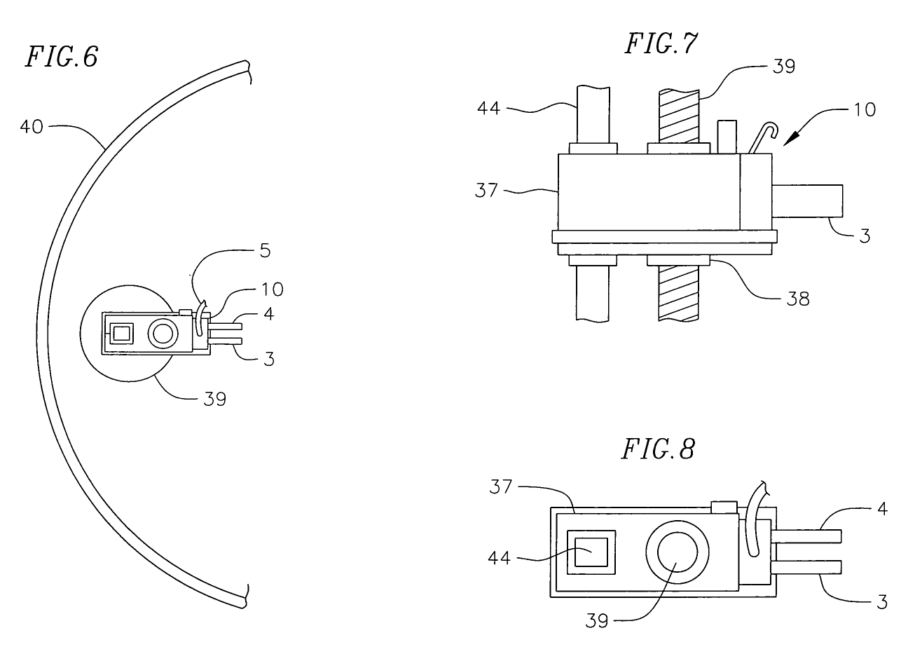

A housing 12 for the capacitive probe is shown in block form in FIGS. 4-7. The capacitor plates 3 and 4 extend from the housing 12 and are in electrical contact with the electronics in the housing 12.

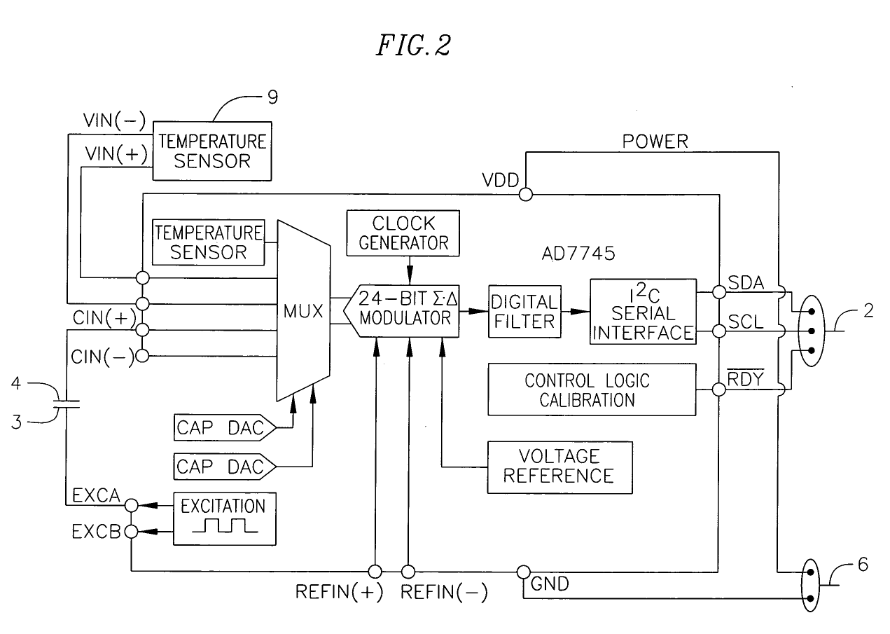

The functional block diagram of dielectric to digital converter is shown in FIG. 2. The particular capacitance to digital converter or dielectric to digital converter shown in FIG. 2 is an AD7745-24 bit, 1 channel Capacitance to Digital Converter available from Analog Devices (www.analog.com).

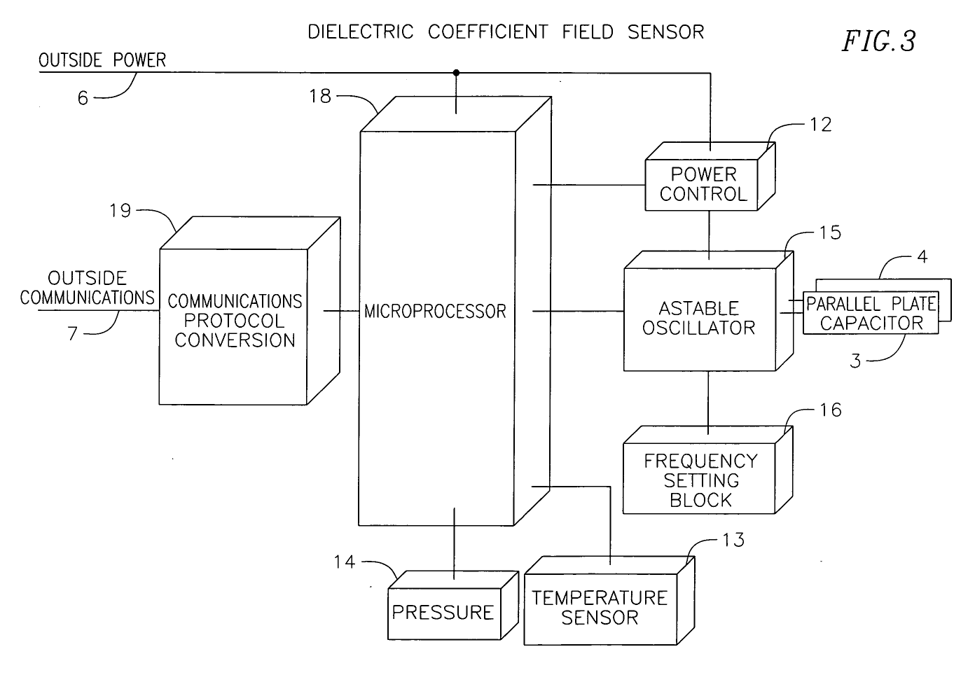

An alternative dielectric to digital converter is shown in block form in FIG. 3. This dielectric to digital converter employs an astable oscillator 15 coupled to parallel capacitor plates 3 and 4. The frequency of the astable oscillator is initially set by a variable resistor in a frequency setting block 16. With air between the capacitor plates 3 and 4, the frequency of the oscillator 15 is set at 200 kilohertz. Thereafter, the frequency of the oscillator 15 varies as the dielectric or liquid between the capacitor plates 3 and 4. The variable frequency, at the output of the oscillator 15, is converted to a digital signal representative of the coefficients of the various liquids that pass between the capacitor plates 3 and 4. The converted coefficient digital signal from the output of the microprocessor 18 is applied to a communications protocol converter 19 for communication with the selected communication network outside the tank. A temperature sensor 13 is coupled as an input to the microprocessor 18 to monitor the temperature of the liquids that pass between the capacitor plates 3 and 4. The pressure of the a single liquid above the capacitive probe may be sensed by a pressure transducer 14 that provides an output that may be used to determine the volume of the single liquid above the pressure transducer 14.

For new tank installation, the capacitive probe may be attached to the wall inside the tank as shown in FIG. 4. A tank 20 diagrammatically shown in FIG. 4 represents a 400-barrel or 500-barrel tank that is commonly used to store liquids at gas well sites. Tank 20 has two outlets that are common in such tanks, the lower one 21 being a drain port and the higher one 22 being the load-out port. Typically the drain port 21 is used to remove water and other liquids to bring the lower surface of the clean oil to a point just above the drain port 21. In this way, the lower surface of the oil is below the load-out port 22 to satisfy a requirement that is common in the gas fields; which is that the lower surface of the clean oil must be 8″ below the center of the load-out port 22. A controller 24 may be attached to the outside of the tank 20 to communicate directly through the wall to the capacitive probe 10. Alternatively, the controller 24 may be placed in a box that is mounted on a pole removed from the tank 20. When the controller is mounted on the outside of the tank, near the capacitive probe inside the tank, the power and data cable 8 is connected directly through the wall of the tank. Alternatively, the power and data cable 8 extends out through the top of the tank 20 to the controller 24.

At most gas well sites the power for instrumentation and other devices is provided by a solar panel 25 and a battery 26. The controller 24 is powered by the solar panel 25. A speaker 28 is coupled to the controller 24 to provide an audible alarm when a liquid that is not authorized for removal is sensed by the capacitance probe 10. A camera 30 may also be mounted on the side of the tank 20 or in some other position to observe and record or take pictures of the truck removing the liquids from the tank 20 and the operator of the truck. The operation of the camera 30 is controlled by the controller 24 and thus the capacitance probe 10 inside the tank 20.

For a further secure operation to limit the removal of only authorized liquids from the tank 20, an automatic valve 31 is provided in the output line from the tank 20. Application software in the controller 24 requires that the operator of the truck that connects to the drain port 21 of the tank 20 must first provide authorization and identification to the controller 24 before the controller 24 will open the valve 31. A water truck may service a plurality of tanks in a given area and, in the interest of the economy, the automated valve 31 may be located on a water truck rather than at each tank that is serviced by a water truck. In any event, the automatic valve will only be activated by the individual controller 24 present at each of the tank sites from which water is to be taken. Another placement for the capacitive sensor (not shown) is in the output line between the valve 31 and drain port 21.

An alternative placement of the capacitive probe 10 is also shown in FIG. 4. For tanks that have been in use or are in use, it is generally not possible to enter the tank 20 to attach the capacitive probe 10 to the inside wall of the tank. Consequently, the capacitive probe 10 is attached to a support pole 33 and inserted through a hole 35 at the top of the tank. Tanks in general use as storage tanks in gas fields have one or more 4″ couplings welded to the top of the tank for access to the inside of the tank. The hole 35 is such a coupling at the top of the tank 20. The capacitive probe 10 is attached to the support pole 33 in a position so that it will be at the desired height relative to the bottom of the tank 20 and the outlet ports 21 and 22 of the tank 20. The support pole 33, with capacitive probe 10, is inserted through the 4″ opening 35 at the top of the tank so that the bottom of the support pole 33 touches the bottom of the tank 20. In this way the capacitive probe 10 is fixed in place inside the tank 20. The bottom of the pole 33 may carry a magnet 36 to position and secure the bottom end of the pole in place.

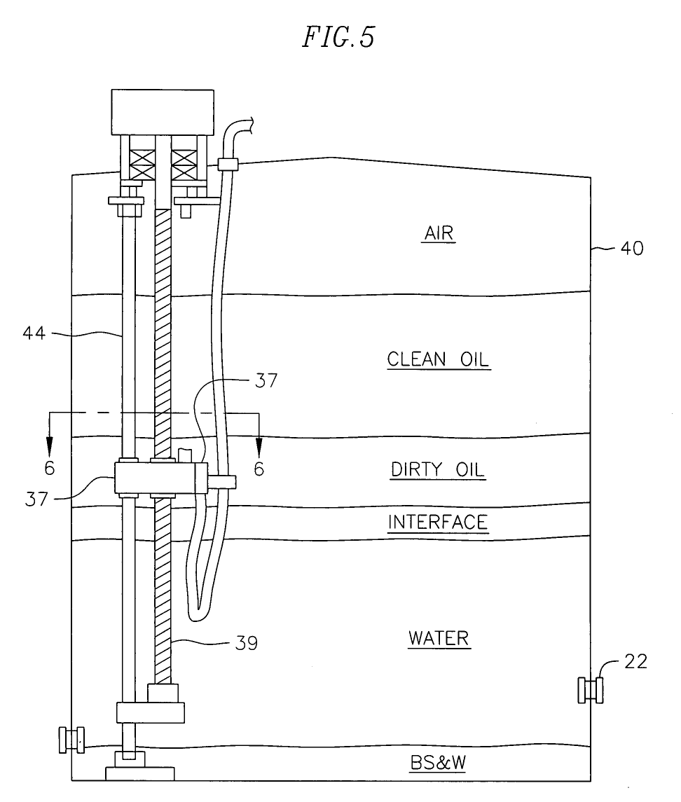

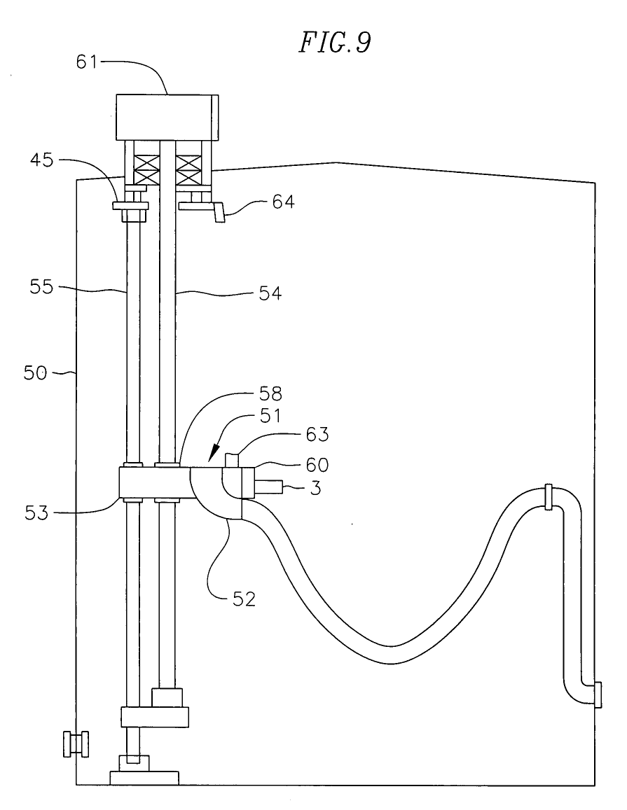

Alternatively, as shown in FIGS. 5-8, the capacitive probe 10 may be attached to a housing 37 that is moveable vertically in the tank 40. The carriage 37 has an internal bushing 38 that functions as a nut on a lead screw 39. The lead screw 39 may be threaded only near the bottom end of the lead screw and the carriage 37 moveable only in the bottom portion of the tank 40 so that the capacitive probe 10 may be positioned in the area of the bottom of the tank relative to outlet ports 41 and 42 of the tank 40. Alternatively, the lead screw 39 may be threaded for nearly its entire length so that the capacitive probe 10 may be moved vertically to cover essentially the full height of the tank 40 to identify and discriminate between the contents of the tank 40. Additionally, the position of the carriage 37 to which the capacitive probe 10 is attached is monitored by an encoder, not shown, that tracks the rotations of the lead screw 39 and the position of the carriage 37. The carriage 37 on the lead screw 39 is guided in its vertical movement inside the tank 40 by a support pole 44. The support pole 44 may have any configuration but is shown as having a square cross-section in FIGS. 6 and 8.

Although the capacitive sensor 10 is advantageously used to monitor the removal of liquids from storage tanks at gas wells to prevent the removal of oil, it may also advantageously be used to monitor the removal of any other liquid level from a storage tank. For example, it may be attached to the carriage for a vertically adjustable inlet/outlet orifice 51 as shown in FIG. 9 and more fully described in the concurrently filed application, docket number G13:1068.

What is claimed is:

1. The method of controlling the removal of liquids from a container comprising the steps of sensing the change in a characteristic of the liquid as it passes in contact with a sensor mounted in the container and initiating a process in response to a sensed change.

2. The method in accordance with claim 1 wherein the liquids are natural gas liquids.

3. The method in accordance with claim 2 wherein the process is the controlled delivery of oil from the container.

4. The method in accordance with claim 2 wherein the process is the controlled delivery of water.
